(19) United States
(12) Patent Application Publication
(10) Pub. No.: US 2010/0057255 A1
(43) Pub. Date: Mar. 4, 2010

(54) METHOD FOR CONTROLLING MOTION OF A ROBOT BASED UPON EVOLUTIONARY COMPUTATION AND IMITATION LEARNING

(75) Inventors: Syung-Kwon RA, Seoul (KR); Ga-Lam Park, Seoul (KR); Chang-Hwan Kim, Seoul (KR); Bum-Jae You, Seoul (KR)

Correspondence Address: LEXYOUME IP GROUP, LLC, 5180 PARKSTONE DRIVE, SUITE 175, CHANTILLY, VA, 20151, US

(73) Assignee: Korea Institute of Science and Technology, Seoul (KR)

(21) Appl. No.: 12/238,199

(22) Filed: Sep. 25, 2008

(30) Foreign Application Priority Data
Sep. 1, 2008 (KR) 10-2008-0085922

(51) Int. Cl. B25J 9/00

(52) U.S. Cl. 700/253; 901/2; 901/15

(57) ABSTRACT

The present invention relates to a method for controlling motions of a robot using evolutionary computation, the method including constructing a database by collecting patterns of human motion, evolving the database using a genetic operator that is based upon PCA and dynamics-based optimization, and creating motion of a robot in real time using the evolved database. According to the present invention, with the evolved database, a robot may learn human motions and control optimized motions in real time.

### CROSS-REFERENCE TO RELATED APPLICATION

This application claims priority to and the benefit of Korean Patent Application No. 10-2008-0085922 filed in the Korean Intellectual Property Office on Sep. 1, 2008, the entire contents of which are incorporated herein by reference.

### BACKGROUND OF THE INVENTION

(a) Field of the Invention

The present invention relates to a method for controlling the motion of a robot, and more particularly, to a method for controlling the motion of a robot in real time, after having the robot learn human motion based upon evolutionary computation.

(b) Description of the Related Art

Currently, humanoid robots are becoming increasingly similar to human beings not only in structures or appearances but in their capability of controlling motions such as walking or running. This is because there are continued efforts to cause a robot to produce similar movements to those of a human.

For example, we might be able to store human motions in a database and then cause a robot to imitate the human motions by recreating the stored motions. However, it is physically impossible to record and store in advance every motion required for a robot, and to utilize the stored motions.

When a robot recreates human motions by imitating them based upon a motion capture system, the robot may act in the same natural way as the human does, as long as the captured pattern of human motions is directly applied to the robot. There are, however, many differences in dynamic properties such as mass, center of mass, and inertial mass between a human and a robot. Therefore, the captured motions are not optimal for a robot.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for controlling motion of a robot based upon evolutionary computation, whereby the robot may learn the way a human moves.

According to the present invention, the method for controlling the motion of a robot may include the steps of (a) constructing a database by collecting patterns of human motions, (b) evolving the database using a PCA-based genetic operator and dynamics-based optimization, and (c) creating motion of a robot using the evolved database.

The step (a) may further include the step of capturing human motions.

The step (b) may further include the steps of: (b-1) selecting from the database at least one movement primitive with a condition similar to that of an arbitrary motion to be created by a robot; and (b-2) reconstructing the selected movement primitive by creating an optimal motion via extraction of principal components based upon PCA and combination of the extracted principal components.

The step (b) may further include the step of evolving the database by repeating the steps (b-1) and (b-2).

The arbitrary motion in the step (b-1) may be described as the following equation (1).

$$q ( t ) = {q}_{mean} ( t ) + {\sum }_{i = 1}^{4} {x}_{i} {q}_{{pc}_{i}} ( t ) + {x}_{5} \qquad ( 1 )$$

Here, q(t) is the joint trajectory of the arbitrary motion, qₘₑₐₙ(t) is the average joint trajectory of selected movement primitives, q_{pc}_{ᵢ}(t) is the i-th principal component of the joint trajectories of the selected movement primitives, and xᵢ(i=1, 2, 3, 4, 5) is a scalar coefficient.

The condition of the arbitrary motion may satisfy the following boundary condition (2).

q(t₀)=q₀, q(t_{f})=q_{f}, \dot{q}(t₀)=\dot{q}₀, \dot{q}(t_{f})=\dot{q}_{f} (2)

Here, q₀ is a joint angle at initial time t₀, \dot{q}₀ is a joint velocity at initial time t₀, q_{f} is a joint angle at final time t_{f}, and \dot{q}_{f} is a joint velocity at final time t_{f}.

The step (b-2) may further include the steps of: deriving the average trajectory of a joint trajectory via the following equation (3) as the selected movement primitive includes at least one joint trajectory,

$${q}_{mean} = \frac{1}{k} {\sum }_{i = 1}^{k} {q}_{i} ; \qquad ( 3 )$$

where k is the number of selected movement primitives, and qᵢ is the joint trajectory of the i-th movement primitive;

deriving a covariance matrix (S) using the following equation (4),

$$S = \frac{1}{k} {\sum }_{i = 1}^{k} ( {q}_{i} - {q}_{mean} ) {( {q}_{i} - {q}_{mean} )}^{T} ; \qquad ( 4 )$$

and

obtaining a characteristic vector from the covariance matrix and obtaining a principal component of the joint trajectory from the characteristic vectors.

The step (b-2) may further include the steps of: determining a joint torque (τ) using the following equation (5),

M(q)\ddot{q}+C(q, \dot{q})\dot{q}+N(q, \dot{q})=τ (5)

where q is a joint angle of the selected movement primitive, \dot{q} is a joint velocity of the selected movement primitive, \ddot{q} is a joint acceleration of the selected movement primitive, M(q) is a mass matrix, and C(q, \dot{q}) is a Coriolis vector, and N(q, \dot{q}) includes gravity and other forces; and

determining the selected movement primitive to be the optimal motion if the determined joint torque minimizes the following formula (6)

$$\frac{1}{2} {\int }_{{t}_{0}}^{{t}_{f}} {‖ τ ( q , \dot{q} , \ddot{q} ) ‖}^{2} d t . \qquad ( 6 )$$

The step (c) may use PCA and motion reconstitution via kinematic interpolation.

The step (c) may further include the steps of: (c-1) selecting from the evolved database at least one movement primitive with a condition similar to that of a motion to be created by a robot; and (b-2) reconstructing the selected movement primitive by creating an optimal motion via extraction of principal components based upon PCA and combination of the extracted principal components.

The motion in the step (c-1) to be created by a robot may be described as the following equation (7).

$$q ( t ) = {q}_{mean} ( t ) + {\sum }_{i = 1}^{3} {x}_{i} {q}_{{pc}_{i}} ( t ) + {x}_{4} \qquad ( 7 )$$

Here, q(t) is the joint trajectory of the motion to be created by the robot, qₘₑₐₙ(t) is the average joint trajectory of the selected movement primitives, q_{pc}_{ᵢ}(t) is the i-th principal component of the joint trajectories of the selected movement primitives, and xᵢ(i=1, 2, 3, 4) is a scalar coefficient.

The condition of the motion to be created by a robot may satisfy the following boundary condition (8).

q(t₀)=q₀, q(t_{f})=q_{f}, \dot{q}(t₀)=\dot{q}₀, \dot{q}(t_{f})=\dot{q}_{f} (8)

Here, q₀ is a joint angle at initial time t₀, \dot{q}₀ is a joint velocity at initial time t₀, q_{f} is a joint angle at final time t_{f}, and \dot{q}_{f} is a joint velocity at final time t_{f}.

The step (c-2) may further include the steps of: deriving the average trajectory of a joint trajectory via the following equation (9) as the selected movement primitive includes at least one joint trajectory,

$${q}_{mean} = \frac{1}{k} {\sum }_{i = 1}^{k} {q}_{i} \qquad ( 9 )$$

where k is the number of the selected movement primitives, and qᵢ is the joint trajectory of the i-th movement primitive;

deriving a covariance matrix (S) using the following equation (10),

$$S = \frac{1}{k} {\sum }_{i = 1}^{k} ( {q}_{i} - {q}_{mean} ) {( {q}_{i} - {q}_{mean} )}^{T} ; \qquad ( 10 )$$

and

obtaining a characteristic vector from the covariance matrix and obtaining a principal component of the joint trajectory from the characteristic vectors.

According to the present invention, by evolving human movement primitives so as to be applicable to the characteristics of a robot, the robot can perform an optimal motion.

In addition, according to the present invention, a robot can create a motion in real time based upon the evolved database.

Further, according to the present invention, as long as motion capture data is available, a robot can imitate and recreate various kinds of human motions because the motion capture data can be easily applied to a robot.

### BRIEF DESCRIPTION OF THE DRAWINGS

FIG. 1 is a schematic view of a PCA-based genetic operator according to an exemplary embodiment of the present invention.

FIG. 2 is a schematic view of a process wherein a movement primitive evolves using the genetic operator and the fitness function according to an exemplary embodiment of the present invention.

FIG. 3 is a schematic view comparing a prior art and a method according to an exemplary embodiment of the present invention.

FIG. 4A is a perspective view of a humanoid robot “MAHRU”, which was used in the experimental example.

FIG. 4B is a schematic view of a 7-degrees-of-freedom manipulator that includes waist articulation and a right arm.

FIG. 5A is a perspective view of an experimenter before catching a ball thrown to him.

FIG. 5B is a perspective view of the experimenter who is catching a ball thrown to him.

FIG. 5C is a perspective view of the experimenter who is catching a ball thrown above his shoulder.

FIG. 6A is a front view of 140 catching points where the experimenter caught the balls.

FIG. 6B is a side view of 140 catching points where the experimenter caught the balls.

FIG. 7A is a view of joint angle trajectories of 10 arbitrarily chosen movement primitives.

FIG. 7B is a view of 4 dominant principal components extracted from the movement primitives shown in FIG. 7A.

FIG. 8A is a graph showing the number of parents being replaced by better offspring.

FIG. 8B is a graph showing the average value of fitness function of individuals in each generation.

FIG. 9A is a front view of a robot's motion created by a prior method 1.

FIG. 9B is a front view of a robot's motion created by a method 3 according to an exemplary embodiment of the present invention.

FIG. 9C is a side view of a robot's motion created by a prior method 1.

FIG. 9D is a side view of a robot's motion created by a method 3 according to an exemplary embodiment of the present invention.

FIG. 10 is a view showing the joint angle of motions created by a prior method 1 and by a method 3 according to an exemplary embodiment of the present invention, respectively.

FIG. 11A is a front view of a robot's motion created by a prior method 2.

FIG. 11B is a front view of a robot's motion created by a method 3 according to an exemplary embodiment of the present invention.

FIG. 11C is a side view of a robot's motion created by a prior method 2.

FIG. 11D is a side view of a robot's motion created by a method 3 according to an exemplary embodiment of the present invention.

FIG. 12 is a view showing the joint angle of motions created by a prior method 2 and by a method 3 according to an exemplary embodiment of the present invention, respectively.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. For a clear explanation of the present invention, parts unrelated to the explanation are omitted from the drawings, and like reference symbols indicate the same or similar components in the whole specification.

A robot's motion includes a task and a condition. For example, in a motion of stretching a hand toward a cup on a table, stretching the hand toward the cup is the task of the motion and the position of the cup on the table is the condition of the motion. However, it is physically impossible to store each motion of stretching a hand to a cup in every position and to utilize the motion.

In an exemplary embodiment of the present invention, limited numbers of motions are stored, and a motion with at least one joint trajectory is defined as a movement primitive. In addition, in an exemplary embodiment of the present invention, motions of a robot's arm for various conditions such as the position of the cup are created via interpolation of the movement primitive.

A movement primitive is an individual in evolutionary computation. For instance, if a movement primitive has a two-minute joint angle trajectory with a sampled rate of 120 Hz, its genotype is 14,400-dimensional real-valued vector (14,440=2 min×120 Hz×60 sec). In addition, limited number of selected movement primitives become a group and act as parent individuals.

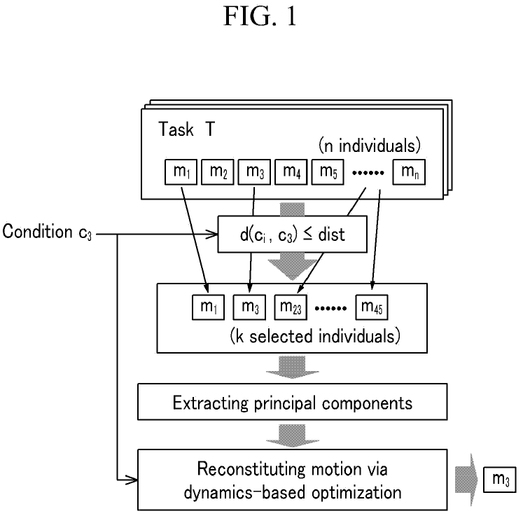

FIG. 1 is a schematic view of a PCA-based genetic operator according to an exemplary embodiment of the present invention.

Referring to FIG. 1, n movement primitives that belong to a task T make parents. If each movement primitive is designated as one of m₁ to mₙ, it has its own condition. That is, the condition of the movement primitive mᵢ is designated as cᵢ.

If a motion with the condition c₃ is needed, k movement primitives with conditions similar to the condition c₃ are selected from n parents. The analogousness between the conditions is determined by a suitable distance metric.

For example, if a cup is placed at a specific position, an arm's motion of stretching a hand toward the specific position is needed. In this case, a three-dimensional position vector of the cup is defined as the condition c₃, and a distance metric of d(cᵢ−c₃=∥cᵢ−c₃∥ is used to compare the analogousness of the conditions.

K movement primitives are selected and designated as p₁, p₂, . . . , pₖ. One movement primitive includes a plurality of joint trajectories. For example, if a motion of a manipulator with seven degrees of freedom is described, a movement primitive includes seven joint trajectories.

Joint trajectories with the first degree of freedom, obtained from k movement primitives, p₁, p₂, . . . , pₖ, are designated as q₁, q₂, . . . , qₖ, respectively. The average trajectory qₘₑₐₙ is obtained via the following equation (1).

$${q}_{mean} = \frac{1}{k} {\sum }_{i = 1}^{k} {q}_{i} \qquad ( 1 )$$

In addition, a covariance matrix S is obtained via the following equation (2).

$$S = \frac{1}{k} {\sum }_{i = 1}^{k} ( {q}_{i} - {q}_{mean} ) {( {q}_{i} - {q}_{mean} )}^{T} \qquad ( 2 )$$

The eigenvectors and eigenvalues obtained from the covariance matrix S are designated as ε₁, ε₂, . . . , εₖ and λ₁, λ₂, . . . , λₖ, respectively. Here, the eigenvalues are aligned as λ₁≧λ₂≧ . . . ≧λₖ≧0.

The eigenvectors ε₁ε₂, . . . , εₖ are defined as principal components, and the principal components indicate the respective joint trajectories. According to the characteristics of principal component analysis (PCA), a certain number of principal components can be used to determine the characteristics of the entire joint trajectories. This is because PCA projects high-dimensional data onto a lower-dimensional subspace.

Consequently, the average joint trajectory qₘₑₐₙ and k principal components q_{pc}_{₁}, q_{pc}_{₂}, . . . , q_{pc}_{_{±}} can be obtained from the joint trajectories q₁, q₂, . . . , qₖ with the first degree of freedom. The same process is applied to the trajectories of the second, third, etc. joint, and the average joint trajectory and principal components of each joint can be obtained.

Incidentally, arbitrary motion of a robot can be expressed as a linear combination of an average joint trajectory and principal components, as shown in the following equation (3).

$$q ( t ) = {q}_{mean} ( t ) + {\sum }_{i = 1}^{4} {x}_{i} {q}_{{pc}_{i}} ( t ) + {x}_{5} \qquad ( 3 )$$

Here, q(t) is a joint trajectory, qₘₑₐₙ(t) is an average joint trajectory, and q_{pc}_{ᵢ}(t) is the i-th principal component. Further, xᵢ (i=1, 2, 3, 4, 5) is a scalar coefficient.

Generally the condition c₃ includes a joint position q₀ and a joint velocity \dot{q}₀ at initial time t₀, and a joint position q_{f} and a joint velocity \dot{q}_{f} at final time t_{f}.

Given the five unknowns xᵢ that satisfy four boundary conditions, an optimization process is performed via the following formula (4) and equation (5) in order to determine the unknowns.

$$\begin{matrix}\frac{1}{2} {\int }_{{t}_{0}}^{{t}_{f}} {‖ τ ( q , \dot{q} , \ddot{q} ) ‖}^{2} d t & ( 4 ) \\ M ( q ) \ddot{q} + C ( q , \dot{q} ) \dot{q} + N ( q , \dot{q} ) = τ & ( 5 )\end{matrix}$$

Here, τ is a joint torque vector. The joint torque vector can be calculated via the equation (5) when a joint trajectory q, a joint velocity \dot{q}, and a joint acceleration \ddot{q} are determined. The formula (4) that is to be minimized is a sum of torques that a robot needs when operating the movement primitives.

Through the above optimization process, a new movement primitive m₃ can be created. It requires the minimum energy (torque) and meets the condition c₃. The above process is defined as “reconstituting motion via dynamics-based optimization.”

The newly-created offspring m₃ has the same condition c₃ as that of the parent m₃. The offspring m₃, however, might be a different movement since the offspring was created by decomposing principal components of several individuals including the parent m₃ and recombining them. Therefore, the superiority between the two individuals is determined within the evolutionary computation and then the superior one will belong to the parents of the next generation. With these processes being applied to from c₀ to cₙ, n offspring are created.

Incidentally, in order to select a superior movement primitive between mᵢ in the parents and mᵢ in the offspring as a parent of the next generation, a fitness function is needed. The fitness function is defined as the following formula (6).

$$\frac{1}{2} {\int }_{{t}_{0}}^{{t}_{f}} {‖ τ ( q , \dot{q} , \ddot{q} ) ‖}^{2} d t \qquad ( 6 )$$

That is, one movement primitive that expends less torque (energy) than the other becomes a parent of the next generation.

The formula (6) is the same as the formula (4). That is, the fitness function used in the dynamics-based optimization is the same as the object function used in the evolutionary computation. This is because a genetic operator is intended to work as a local optimizer whereas the evolutionary algorithm is intended to work as a global optimizer. In other words, it is intended that as the local and global optimization occur simultaneously, the movement primitives that form a group gradually evolve into an energy efficient motion pattern requiring less torque.

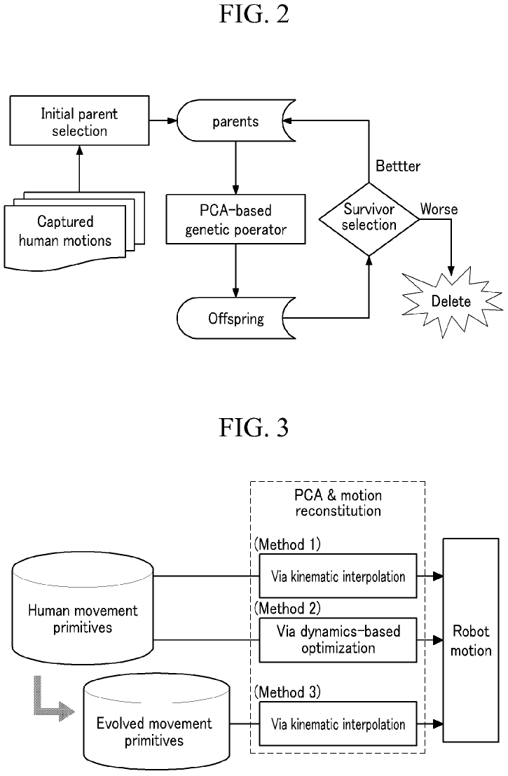

FIG. 2 is a schematic view of a process wherein a movement primitive evolves using the genetic operator and the fitness function according to an exemplary embodiment of the present invention.

By capturing human motions, we select initial parents from repetitive motions that perform one task. These repetitive motions are selected so that they contain various conditions.

Then, movement primitives are extracted from the initial parents, and the extracted movement primitives form the offspring via PCA-based genetic operator.

Then, movement primitives from the parents and offspring are compared and the superior movement primitives form a parent of the next generation and the inferior ones are discarded. This process takes a lot of time due to the massive amount of calculation in the dynamics-based optimization that is used in the genetic operator.

Then, using the evolved movement primitives created as above, a robot can create each motion required at the moment. This process is also made up of PCA of the movement primitives and the recombination of them. That is, if a robot needs to create a motion with an arbitrary condition cᵢ, it extracts from the evolved database motions with a similar condition to cᵢ and obtains an average joint trajectory and principal components via PCA. So far, the process is the same as that in the PCA-based genetic operator.

However, it is different from that in the PCA-based genetic operator in that it uses only the average trajectory and three principal components as shown in the following equation (7).

$$q ( t ) = {q}_{mean} ( t ) + {\sum }_{i = 1}^{3} {x}_{i} {q}_{{pc}_{i}} ( t ) + {x}_{4} \qquad ( 7 )$$

Here, q(t) is the joint trajectory, qₘₑₐₙ(t) is the average joint trajectory, and q_{pc}_{ᵢ}(t) is the i-th principal component. Further, xᵢ (i=1, 2, 3, 4) is a scalar coefficient.

Generally, a condition c₃ is defined with four values, which include a joint trajectory q₀ and joint velocity \dot{q}₀ at initial time t₀, and a joint trajectory q_{f} and joint velocity \dot{q}_{f} at final time t_{f}.

However, different from the PCA-based genetic operator, the number of unknowns is four so that the process of determining the four unknowns that meet four boundary conditions is a simple matrix calculation. Therefore, a motion can be created in real time.

This process is defined as “reconstituting motion via kinematic interpolation” because it creates a motion by considering only the joint trajectories and joint velocities on the boundary.

In an exemplary embodiment of the present invention, reconstituting motion via dynamics-based optimization as well as kinematic interpolation is used together with PCA of the movement primitives.

Reconstituting motion via dynamics-based optimization has a merit that a motion optimized for the physical properties of a robot can be created. However, it also has a drawback because the robot cannot create a motion in real time due to the long time needed for optimization.

On the other hand, by reconstituting motion via kinematic interpolation, a robot can create a motion in real time because of the simple matrix calculation. However, the created motion is not optimal for a robot because it is only a mathematical and kinematic interpolation of captured human motions.

FIG. 3 is a schematic view comparing a prior art and a method according to an exemplary embodiment of the present invention.

Prior methods 1 and 2 apply PCA and reconstitution of motions directly to human motion capture data.

On the other hand, a method 3 according to an exemplary embodiment of the present invention evolves human motion capture data and applies the physical properties of a robot to the data. Further, a robot obtains a required motion in real time based upon the evolved movement primitives.

Hereinafter, an experimental example and a comparative example of a method for controlling motions of a robot according to an exemplary embodiment of the present invention will be explained. However, the present invention is not limited to the following experimental example or comparative example.

### EXPERIMENTAL EXAMPLE

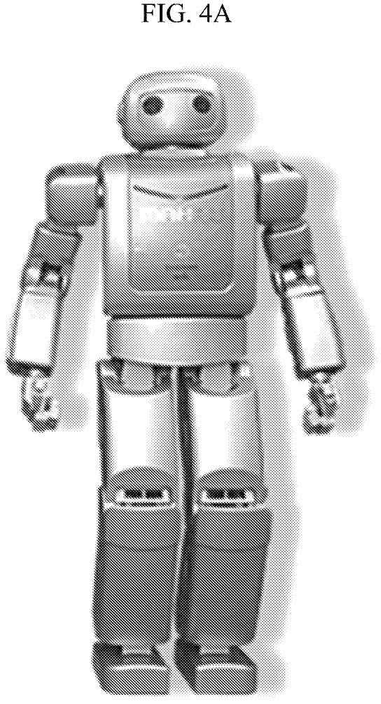

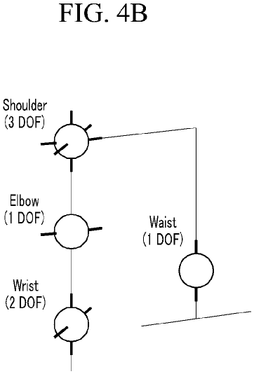

FIG. 4A is a perspective view of a humanoid robot “MAHRU,” which were used in the experimental example, and FIG. 4B is a schematic view of a 7-degree-of-freedom manipulator that includes waist articulation and a right arm.

In order for a robot to catch a thrown ball, the robot has to be capable of tracing the position of the ball and expecting where it can catch the ball. In addition, the robot has to be capable of moving its hand toward the expected position and grabbing the ball with fingers. However, the object of the experimental example is to get a robot to create a human-like movement so that it is assumed that the other capabilities are already given.

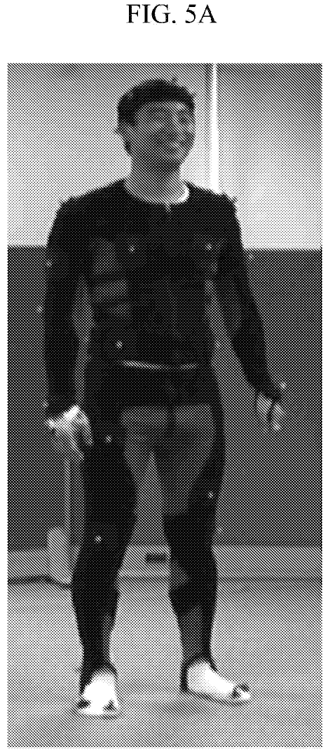

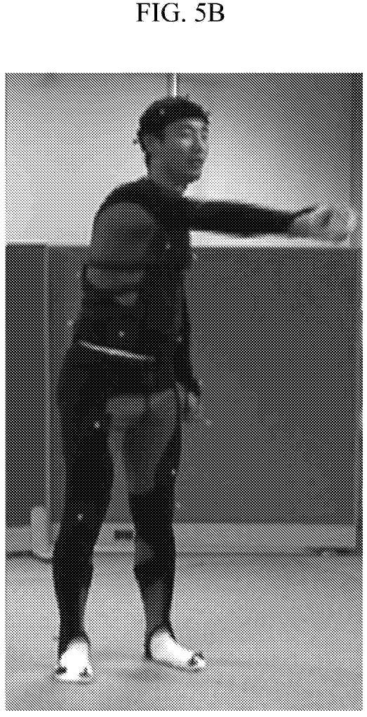

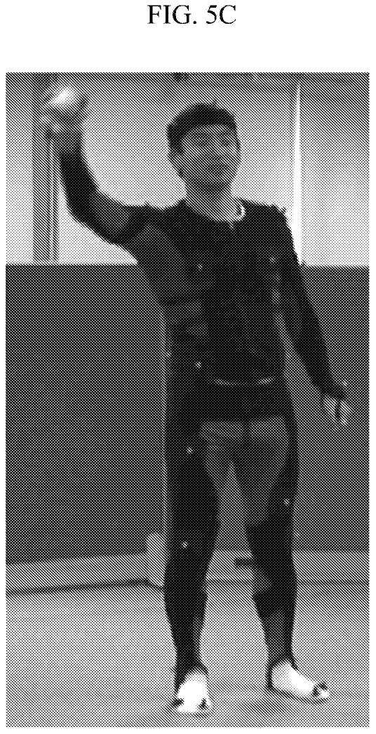

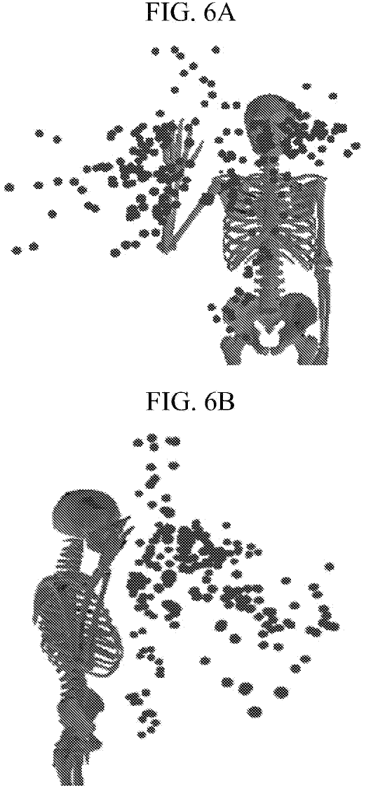

FIG. 5A is a perspective view of an experimenter before catching a ball thrown to him, FIG. 5B is a perspective view of the experimenter who is catching a ball thrown to him, and FIG. 5C is a perspective view of the experimenter who is catching a ball thrown above his shoulder. FIG. 6A is a front view of 140 catching points where the experimenter caught the balls, and FIG. 6B is a side view of 140 catching points where the experimenter caught the balls.

We threw a ball toward various points around the experimenter's upper body, and captured the experimenter's motion of catching a total of 140 balls. In other words, 140 movement primitives formed an initial parent generation in this experimental example.

The condition cᵢ is defined by the following equation (8).

cᵢ=(Rᵢ, pᵢ) (8)

Here, Rᵢ is a rotation matrix of the experimenter's palm at the moment of catching the ball, and pᵢ is a position vector of the palm at the same moment. In addition, both the matrix and the vector are values when viewed from a coordinate located at the waist of the experimenter.

The following equation (9) is defined as a distance metric showing similarities between the respective movement primitives.

d(cᵢ, cⱼ)=w₁∥pᵢ−pⱼ∥+w₂∥Rᵢ^{T}Rⱼ∥ (9)

Here, Rᵢ and pᵢ belong to the condition cᵢ, and Rⱼ and pⱼ belong to the condition cⱼ. Further, w₁ and w₂ are scalar weighting coefficients, which are set to be 1.0 and 0.5, respectively, in this experimental example.

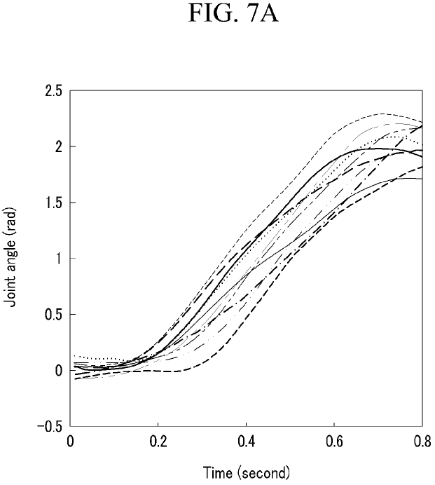

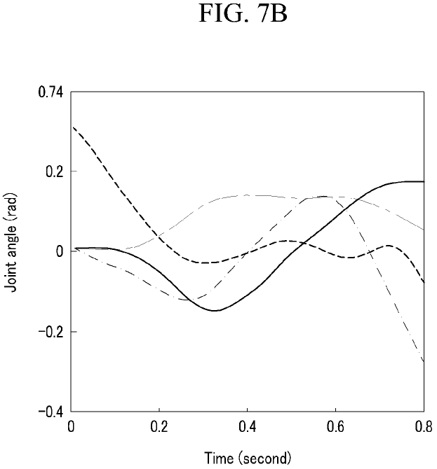

FIG. 7A and FIG. 7B show an example of PCA of the movement primitives. In other words, FIG. 7A is a view of joint angle trajectories of 10 arbitrarily chosen movement primitives, and FIG. 7B is a view of 4 dominant principal components extracted from the movement primitives shown in FIG. 7A.

In this experimental example, we selected twenty movement primitives most similar to the given condition and extracted principal components. Further, we used the principal components in order to create new motions.

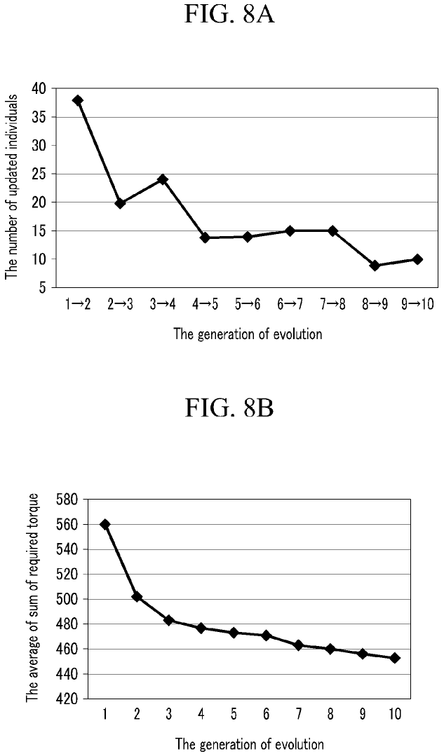

FIG. 8A is a graph showing the number of parents being replaced by better offspring. Further, FIG. 8B is a graph showing the average value of fitness function of individuals in each generation.

Referring to FIG. 8A, during the evolution from the first generation to the second generation, 38 out of 140 parents were replaced by superior offspring. Further, the number of replaced parents dropped as the evolution continued, which shows that the optimization of the movement primitives converges to a certain value.

Referring to FIG. 8B, the average value of the fitness function was almost 560, whereas it went below 460 in the tenth generation after the evolution.

It took approximately nine hours for a Pentium 4 computer having a 2 GB ram to evolve from the first to the tenth generation (hereinafter, the same computer was used).

### Comparative Example 1

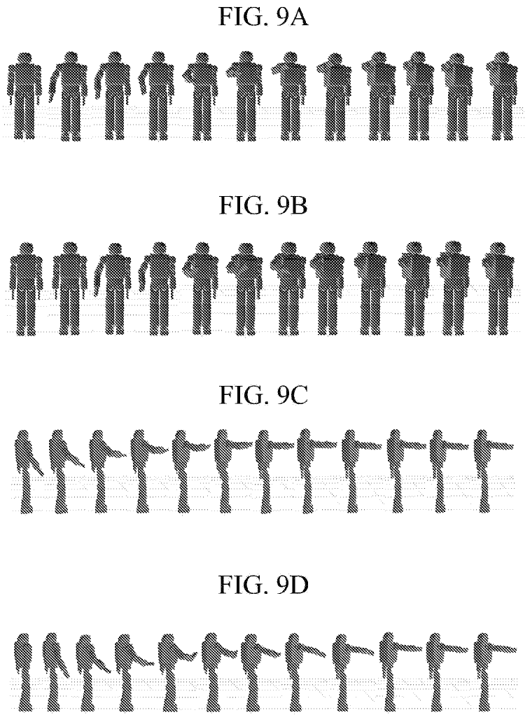

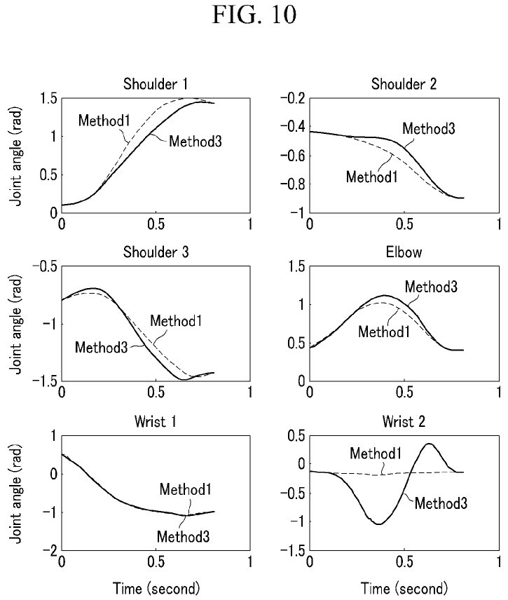

FIG. 9A is a front view of a robot's motion created by a prior method 1, and FIG. 9B is a front view of a robot's motion created by a method 3 according to an exemplary embodiment of the present invention. In addition, FIG. 9C is a side view of a robot's motion created by a prior method 1, and FIG. 9D is a side view of a robot's motion created by a method 3 according to an exemplary embodiment of the present invention. Further, FIG. 10 is a view showing the joint angle of motions created by a prior method 1 and by a method 3 according to an exemplary embodiment of the present invention, respectively.

The two motions look human-like because they basically use captured human motions. Furthermore, the two motions have the same joint trajectories and joint velocities at initial and final time, respectively, because they are created with the same condition.

However, the trajectories from initial point to final point are different, the effects of which are shown in the following Table 1.

TABLE 1

| | Method 1 | Method 3 |
|---|---|---|
| Computational performance | 0.092 sec | 0.101 sec |
| Fitness function value | 370.0 | 275.8 |

Referring to Table 1, the two methods have almost the same computational performances that are close to real-time. This is because the algorithm for creating motions is the same even though the two methods use different sets of movement primitives: evolved or not.

On the other hand, the method 3 has a smaller fitness function value. This means that the motions created by the method 3 are optimized ones, which require less torque and are more energy efficient. Consequently, we found that the evolved database, used in the method 3 according to an exemplary embodiment of the present invention, contributed to creating optimal motions.

### Comparative Example 2

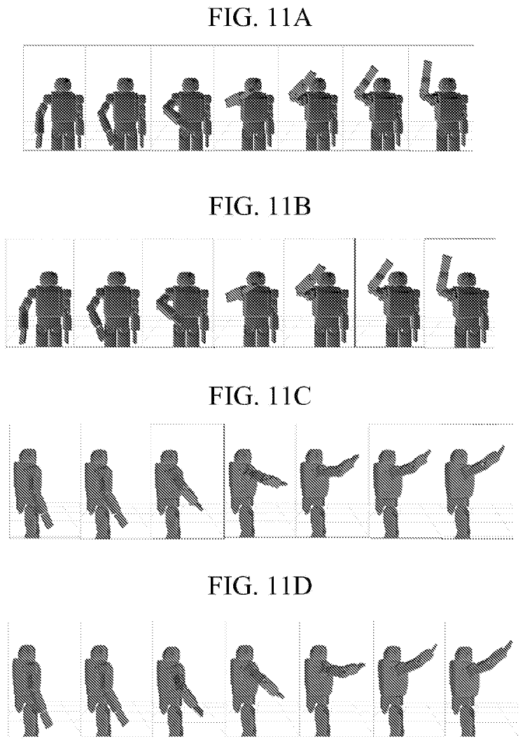

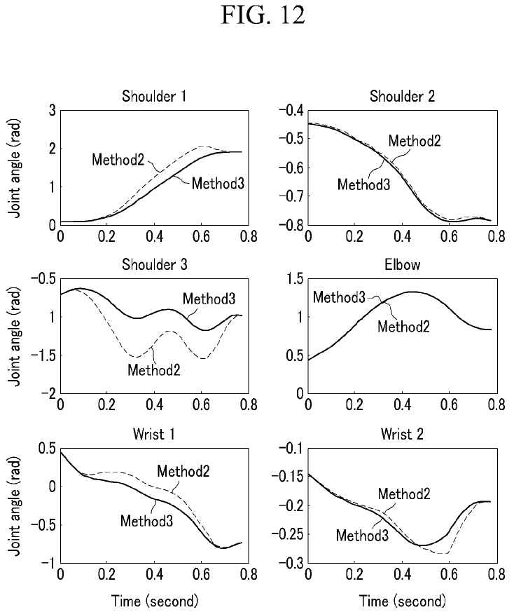

FIG. 11A is a front view of a robot's motion created by a prior method 2, and FIG. 11B is a front view of a robot's motion created by a method 3 according to an exemplary embodiment of the present invention. In addition, FIG. 11C is a side view of a robot's motion created by a prior method 2, and FIG. 11D is a side view of a robot's motion created by a method 3 according to an exemplary embodiment of the present invention. Further, FIG. 12 is a view showing the joint angle of motions created by a prior method 2 and by a method 3 according to an exemplary embodiment of the present invention, respectively.

The two motions look human-like because they basically use captured human motions. Furthermore, the two motions have the same joint trajectories and joint velocities at initial and final times, respectively, because they are created with the same condition.

However, they have different computational performances and fitness function values, which are shown in the following Table 2.

TABLE 2

| | Method 2 | Method 3 |
|---|---|---|
| Computational performance | 11.32 sec | 0.127 sec |
| Fitness function value | 348.7 | 385.1 |

Referring to Table 2, the computational performance of the prior method 2 was 11.32 seconds, whereas the computational performance of the method 3 according to an exemplary embodiment of the present invention was only 0.127 seconds.

In the case of the prior method 2, the calculation took a long time due to the dynamics-based optimization. On the other hand, with the fitness function value of 348.7, the prior method 2 shows more optimized results than the method 3 according to an exemplary embodiment of the present invention. In other words, the robot's motion created by the prior method 2 was the most energy efficient and optimized. However, the method 2 was not appropriate for creating real-time motions due to the long creation time.

On the other hand, the robot's motion created by the method 3 according to an exemplary embodiment of the present invention was less optimized than the prior method 2. However, the method 3 was appropriate for creating real-time motions considering the short creation time.

### Comparative Example 3

With ten conditions, we created motions using the methods 1, 2, and 3, respectively.

Table 3 shows the results that compare the performances after averaging each of the ten motions that were created.

TABLE 3

| | Method 1 | Method 2 | Method 3 |
|---|---|---|---|
| Computational performance | 0.109 sec | 13.21 sec | 0.115 sec |
| Fitness function value | 498.7 | 372.6 | 428.4 |

Referring to Table 3, the prior method 1 and the method 3 according to an exemplary embodiment of the present invention could be applied to creating real-time motions because of the short creation time.

On the other hand, the method 2 had the smallest fitness function value and created optimal motions. However, it was difficult to apply the method 2 to creating real-time motions.

In sum, we could create real-time motions by the method 3 according to an exemplary embodiment of the present invention. Further, the motions created by the method 3 showed almost equal optimization to those created by a long optimization time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling the motion of a robot, the method comprising the steps of:
(a) constructing a database by collecting patterns of human motions;
(b) evolving the database using a PCA-based genetic operator and dynamics-based optimization; and
(c) creating motion of a robot using the evolved database.

2. The method of claim 1, wherein the step (a) further comprises the step of capturing human motions.

3. The method of claim 1, wherein the step (b) further comprises the steps of:
(b-1) selecting from the database at least one movement primitive with a condition similar to that of an arbitrary motion to be created by a robot; and
(b-2) reconstructing the selected movement primitive by creating an optimal motion via extraction of principal components based upon PCA and combination of the extracted principal components.

4. The method of claim 3, wherein the step (b) further comprises the step of evolving the database by repeating the steps (b-1) and (b-2).

5. The method of claim 3, wherein the arbitrary motion in the step (b-1) is described as the following equation (1):
$$q ( t ) = {q}_{mean} ( t ) + {\sum }_{i = 1}^{4} {x}_{i} {q}_{{pc}_{i}} ( t ) + {x}_{5} \qquad ( 1 )$$
where q(t) is the joint trajectory of the arbitrary motion, qₘₑₐₙ(t) is the average joint trajectory of selected movement primitives, q_{pc}_{ᵢ}(t) is the i-th principal component of the joint trajectories of the selected movement primitives, and xᵢ(i=1, 2, 3, 4, 5) is a scalar coefficient.

6. The method of claim 5, wherein the condition of the arbitrary motion satisfies the following boundary condition (2):
q(t₀)=q₀, q(t_{f})=q_{f}, \dot{q}(t₀)=\dot{q}₀, \dot{q}(t_{f})=\dot{q}_{f} (2)
where q₀ is a joint angle at initial time t₀, \dot{q}₀ is a joint velocity at initial time t₀, q_{f} is a joint angle at final time t_{f}, and \dot{q}_{f} is a joint velocity at final time t_{f}.

7. The method of claim 3, wherein the step (b-2) further comprises the steps of:
deriving the average trajectory of a joint trajectory via the following equation (3) as the selected movement primitive includes at least one joint trajectory,
$${q}_{mean} = \frac{1}{k} {\sum }_{i = 1}^{k} {q}_{i} \qquad ( 3 )$$
where k is the number of the selected movement primitives, and qᵢ is the joint trajectory of the i-th movement primitive;
deriving a covariance matrix (S) using the following equation (4),
$$S = \frac{1}{k} {\sum }_{i = 1}^{k} ( {q}_{i} - {q}_{mean} ) {( {q}_{i} - {q}_{mean} )}^{T} ; \qquad ( 4 )$$
obtaining a characteristic vector from the covariance matrix; and
obtaining a principal component of the joint trajectory from the characteristic vectors.

8. The method of claim 3, wherein the step (b-2) further comprises the steps of:
determining a joint torque (τ) using the following equation (5),
M(q)\ddot{q}+C(q, \dot{q})\dot{q}+N(q, \dot{q})=τ (5)
where q is a joint angle of the selected movement primitive, \dot{q} is a joint velocity of the selected movement primitive, \ddot{q} is a joint acceleration of the selected movement primitive, M(q) is a mass matrix, and C(q, \dot{q}) is a Coriolis vector, and N(q, \dot{q}) includes gravity and other forces; and
determining the selected movement primitive to be the optimal motion if the determined joint torque minimizes the following formula (6)
$$\frac{1}{2} {\int }_{{t}_{0}}^{{t}_{f}} {‖ τ ( q , \dot{q} , \ddot{q} ) ‖}^{2} d t . \qquad ( 6 )$$

9. The method of claim 1, wherein the step (c) uses PCA and motion reconstitution via kinematic interpolation.

10. The method of claim 9, wherein the step (c) further comprises the steps of:
(c-1) selecting from the evolved database at least one movement primitive with a condition similar to that of a motion to be created by a robot; and
(b-2) reconstructing the selected movement primitive by creating an optimal motion via extraction of principal components based upon PCA and combination of the extracted principal components.

11. The method of claim 10, wherein the motion in the step (c-1) to be created by a robot is described as the following equation (7):
$$q ( t ) = {q}_{mean} ( t ) + {\sum }_{i = 1}^{3} {x}_{i} {q}_{{pc}_{i}} ( t ) + {x}_{4} \qquad ( 7 )$$
where q(t) is the joint trajectory of the motion to be created by the robot, qₘₑₐₙ(t) is the average joint trajectory of the selected movement primitives, q_{pc}_{ᵢ}(t) is the i-th principal component of the joint trajectories of the selected movement primitives, and xᵢ(i=1, 2, 3, 4) is a scalar coefficient.

12. The method of claim 11, wherein the condition of the motion to be created by a robot meets the following boundary condition (8):
q(t₀)=q₀, q(t_{f})=q_{f}, \dot{q}(t₀)=\dot{q}₀, \dot{q}(t_{f})=\dot{q}_{f} (8)
where q₀ is a joint angle at initial time t₀, \dot{q}₀ is a joint velocity at initial time t₀, q_{f} is a joint angle at final time t_{f}, and \dot{q}_{f} is a joint velocity at final time t_{f}.

13. The method of claim 10, wherein the step (c-2) further comprises the steps of:
deriving the average trajectory of a joint trajectory via the following equation (9) as the selected movement primitive includes at least one joint trajectory,
$${q}_{mean} = \frac{1}{k} {\sum }_{i = 1}^{k} {q}_{i} \qquad ( 9 )$$
where k is the number of the selected movement primitives, and qᵢ is the joint trajectory of the i-th movement primitive;
deriving a covariance matrix (S) using the following equation (10),
$$S = \frac{1}{k} {\sum }_{i = 1}^{k} ( {q}_{i} - {q}_{mean} ) {( {q}_{i} - {q}_{mean} )}^{T} ; \qquad ( 10 )$$
obtaining a characteristic vector from the covariance matrix; and
obtaining a principal component of the joint trajectory from the characteristic vectors.
